(19) United States
(12) Patent Application Publication
(10) Pub. No.: US 2015/0049894 A1
(43) Pub. Date: Feb. 19, 2015

(54) LOW PROFILE FLAT PANEL SPEAKER SYSTEM

(71) Applicant: Polk Audio, LLC, Vista, CA (US)

(72) Inventors: Michael DiTullo, Encinitas, CA (US); Mark Werle, Oceanside, CA (US); Stuart Lumsden, Baltimore, MD (US); Mark Suskind, Baltimore, MD (US)

(73) Assignee: Polk Audio, LLC, Vista, CA (US)

(21) Appl. No.: 14/458,162

(22) Filed: Aug. 12, 2014

Related U.S. Application Data
(60) Provisional application No. 61/865,531, filed on Aug. 13, 2013.

(51) Int. Cl. H04R 1/02

(52) U.S. Cl. CPC H04R 1/028
USPC 381/333

(57) ABSTRACT

A low profile speaker system that can be inconspicuously mounted to the back of a flat panel display and provides an acoustical arrangements to create a full home theater surround sound experience while maintaining a compact enclosure footprint. The speaker system can be supported using a stand; the stand integral to the speaker system support architecture and supporting both the speaker system and flat panel television.

### CROSS-REFERENCE TO RELATED APPLICATIONS

This application claims the benefit of U.S. Provisional Patent Application Ser. No. 61/865,531 filed Aug. 13, 2014 entitled LOW PROFILE FLAT PANEL SPEAKER SYSTEM.

### FIELD OF THE INVENTION

The field of the invention is flat panel TV speaker systems. (or low profile speakers intended for use with flat panel TVs)

### BACKGROUND OF THE INVENTION

Flat panel display technology has advanced quickly in recent years. The size of the panel has increased significantly, with eighty inch screens being common place. The integration of wireless technology, gaming functions, internet access and graphical user interface has become an expectation for consumers regarding flat panel displays. Flat panel televisions and home video entertainment equipment requires sound playback means. Often, the primary use of the flat panel is for home theaters. Consumers have become accustomed to high quality audio for entertainment with 5.1 and 7.1 surround sound and other digital signal processing technologies. For movies, consumers expect a home theater surround sound experience that mimics the actual theater experience. For gamers, the directionality of auditory signals within the gaming experience is a key aspect of the quality of the game. Listeners of both applications have indicated preferences for an immersive sound field.

With an emphasis on thin low profile flat panel displays, it is difficult to provide acceptable sound quality with speakers built into the chassis of the flat panel display. An adequate audio system built into the flat panel chassis require substantial space for speaker drivers, electronics, venting and mounting. Integration of the audio system into the chassis defeats the purpose of the flat panel design and requires a thicker display chassis design. Audio system designers have employed the use of remote speakers, both wired and wireless to overcome this issue and create an acceptable audio listening experience with large thin flat panel display. However, remote speakers must be mounted or place throughout the room. There are usually multiple speakers that must be arranged throughout the room taking up floor space, which may not be aesthetically desirable, may not be desired in a small room and require special tuning and placement to achieve the desired audio effect. Thus, a need exist for a speaker system that produces a high quality surround sound listening experience, while being easily configured for use with a large flat panel display, wherein the speaker system does not require multiple speaker enclosures and is inconspicuously mounted in association with a flat panel display.

### SUMMARY OF THE INVENTION

In order to overcome the limitations of the prior art it is an objected of the present invention to provide a slim, low profile speaker system that can be used with a flat panel display. It is a further object to provide a means for associating the speaker system with the flat panel display that is inconspicuous or that is aesthetically appealing. It is another object of the invention, to allow the system to be configured within an enclosure having electronics and acoustical arrangements that provide a full surround sound experience for listeners while maintaining a compact enclosure footprint. It is yet another object of the invention to provide a home theater audio system mounted to the back of a flat panel display that provides for forward facing audio speakers. It is yet another object of the invention to provide a remote user interface that offers remote user control of the acoustical parameters of the system to optimize the surround sound experience for the particular acoustical environment and listener applications.

The present invention provides a relatively thin low profile speaker system that can be inconspicuously mounted to the rear of a flat panel display using the original flat panel mounting bolt holes intended for use to connect a wall mounting bracket. Standard bolts are used to anchor the speaker system of the current invention to the back of the flat panel display. Bolts are simply inserted through the speaker system in holes configured for alignment with the flat panel factory bold holes and securely tightened. The flat panel display with the speaker system bolted on is then supported by a based structure. The base structure may be the standard base provided with the display. Alternatively, the speaker system can be supported using a stand; the stand is integral to the speaker system support architecture and supports both the speaker system and flat panel television when the speaker system is bolted to the rear of the panel. This is done in a similar fashion as though the panel was simply attached to a base support without the inventive speaker. The stand will have a broad enough base for setting the attached low profile speaker system on a flat surface, and include an upright extension member for firmly securing the speaker system.

### BRIEF DESCRIPTION OF THE DRAWING

FIG. 1 is a schematic diagram showing one half of the interior of the enclosure of the inventive speaker system;

FIG. 2 is a schematic diagram showing the second half of the interior of the enclosure of the inventive speaker system;

FIG. 3A is a perspective diagram showing the coupling configuration of the inventive speaker system and a flat panel display.

FIG. 3B is a perspective diagram showing the inventive speaker system and a flat panel display coupled.

FIG. 4 is perspective diagram showing an expanded view of the forward facing speaker of the inventive speaker system mounted to a flat panel display.

FIG. 5A is perspective diagram showing the inventive speaker system mounted to a flat panel display using the factory base to support the coupled system.

FIG. 5B is perspective diagram showing the inventive speaker system mounted to a flat panel display using the speaker system tripod style stand.

FIG. 6 is perspective diagram showing the inventive speaker system mounted to a flat panel display using the speaker system inserted style stand.

### DESCRIPTION OF THE INVENTION

The invention provides for a slim, low profile speaker system that can be used with a flat panel display. The flat panel speaker system allows mounting in a manner that is inconspicuous or otherwise aesthetically appealing manner while maintaining a full surround sound experience for listeners. A remote user is provided an interface that offers control of the acoustical parameters of the system to optimize the surround sound experience for the particular acoustical environment and listener applications.

Example embodiments are described herein in the context of the disclosed novel speaker system. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiment as illustrated in the accompanying drawings. The same reference indicators will be used throughout the drawings and the following description to refer to the same or like items.

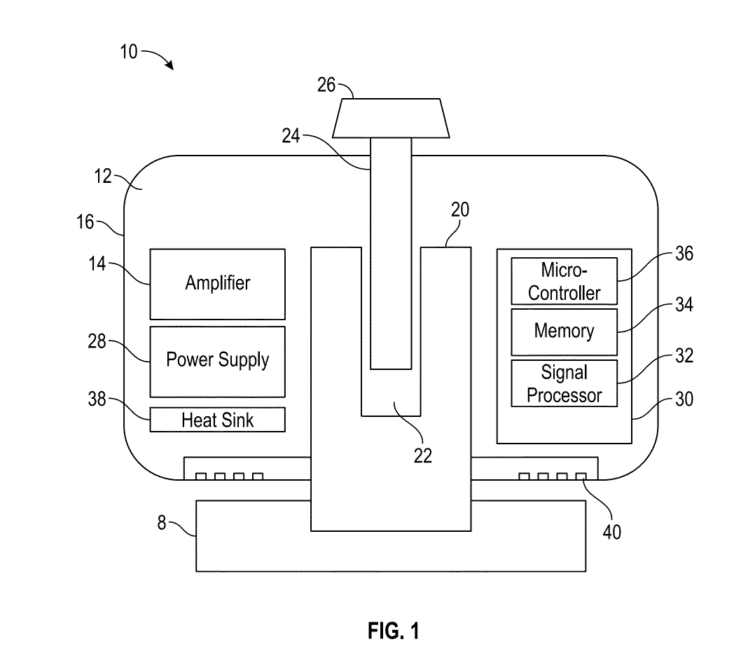

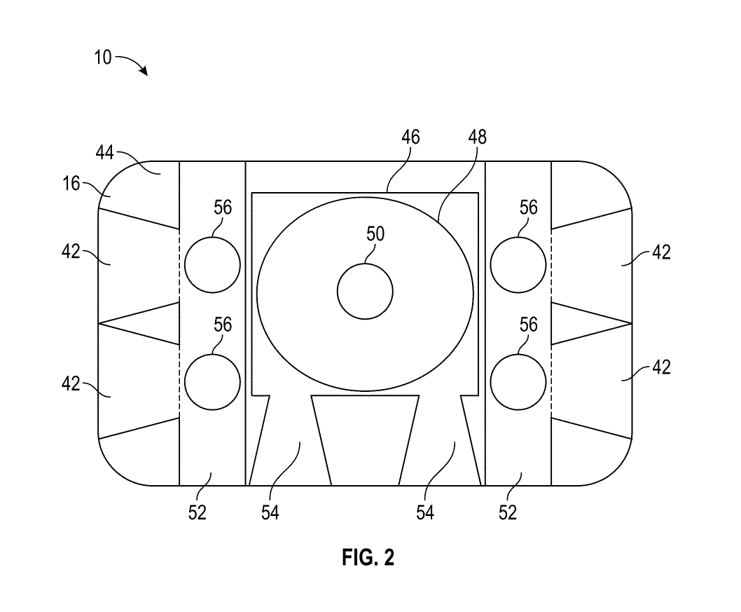

Now with reference to the figures, FIG. 1 and FIG. 2. are schematic representation of two halves 12 and 14 of the enclosure 16 of the flat panel speaker system 10. Each half 12 and 14 provide a housing for various system components. The shape of the enclosure 16 generally conforms to the shape of the flat panel television on which it is mounted and preferably the has a smaller perimeter dimension than that of the flat panel. This allows for concealment of the speaker system 10 when viewed from the front.

FIG. 1 shows the inventive speaker system 10 with the enclosure 16 with a back panel removed. The portion shown is of the flat panel mounting half 14 of the enclosure 16. The enclosure 16 may comprise interior base or stand support 18 with bands or similar reinforcement frame structures (not shown) associated with those areas of the enclosure 16 where the speaker system is bolted to the flat panel and where the base is secured within the speaker system. This provide for additional support and strength when using a base mount stand 8 to provide support of the speaker system 10 and flat panel display when mounted. The base support 18 includes a base upright 20 that extends through the core of the enclosure 16. The upright 20 is supported within the enclosure 16 by reinforced frame structure (not shown). It is contemplated that the reinforced frame support may be a slot where the base upright 20 may be inserted into enclosure 16 within a slot and groove configuration.

In one embodiment of the current invention, at least one forward facing high frequency transducer 26 is mounted upon a adjustable sliding structure 24 that is integrated into the body of the 16 enclosure in a slot and groove configuration 22 similar to the base upright 20. The sliding structure 24 can be raised and lowered to accommodate displays of different sizes. When the speaker system 10 is being stored or transported the structure 24 remains in an un-deployed position. When the speaker system 10 is mounted to the flat panel display the sliding structure 24 is deployed and raised such that the body of the sliding structure can be extend above the bezel edge of the flat panel display and fits optimally to a variety of display sizes. The forward facing speaker 26 provides for transmission of acoustic signals that are strongest at normal voice frequencies to optimize perception of dialog.

Within the mounting half 12 of the enclosure 16, also contained are various electrical components for operation of the audio functions of the system 10. A power supply management module 28 provides electrical current to an amplifier 14 and an integrated circuit board 30 having a microcontroller 36, memory 34 and signal processor 34. A power supply management module 28, which may be located within or be separate and connected by a wire to the enclosure 16. As is known it the art, the system 10 is powered by any 110 volt or 220 volt standard power source and includes a power cord that may be plugged into any standard wall socket. The power management system 28 may allow users to select the preferable voltage level. Selection may be made through a switch associated with the power management module 28 or through the an on-screen display. The power management system 28 may also provide for a power socket to allow for direct plug in of the flat panel display.

The power management system 28 may be associated with a heat sink 38 to provide for the dissipation or excess heat generated from the power management system 28 and electronics module 30. It will be appreciated by one skilled in the art that the heat sink 38 by be configured in a variety of way or located within the enclosure 16 to maximize dissipation of heat.

The electronics module 30 may be an integrated circuit board and include a microcontroller 36, memory 34 and digital signal processor 34. The electronics module 30 is associated with I/O connectors 40 that provide for audio inputs from of various know audio and video inputs and outputs that allow for the receipt and transmission of various know audio and video signals formats. The acoustic signal may be any analog or digital signal received from an independent audio source. Digital audio signal received from through the connectors 40 may be processed within a signal processor 32. The digital signal processing subsystem 32 provides for processing acoustic signals to allow for a full sound stage imaging experience by acoustic and electronic manipulation using digital signal processing and applied psychoacoustic principles.

The digital signal processing module 32 uses a number of known methods, including those discussed in U.S. Provisional Application No. 61/702,728 for processing acoustic signals intended for playback in a single speaker multi-drive surround sound system to allow for a full sound stage imaging and spatial acoustic experience of the listener when listening to the playback of recorded music or when listening to digital movie sound tracks. These methods include signal manipulation associated with Head Related Transfer Functions (HRTFs), Inter Aural Crosstalk (IAC) Cancellation, direct/unprocessed signal, and center channel level. The speaker system 10 is further comprised of an electronics module that is comprised of various know audio and video inputs and outputs that allow for the receipt and transmission of various know audio and video signals formats. The electronic module is further comprised of a digital signal processing subsystem for processing acoustic signals to allow for a full sound stage imaging experience by acoustic and electronic manipulation using digital signal processing and applied psychoacoustic principles. The acoustic signal may be any analog or digital signal received from an independent audio source. Many methods of digital signal processing and applied psychoacoustic principles are known. Many of these processes and principles are discussed in detail in U.S. Provisional Application No. 61/702,728 entitled Acoustic Surround Immersion Control System and Method, which is fully incorporated herein by reference.

The electronics module 30 may include a transceiver and may be selectably be wired or in wireless communication with the flat panel display or other wireless devices, allowing the user to set preferred acoustic parameters such as the volume between the different frequency speakers or audio channels or use the system 10 as an audio output for other electronic devices. Any wireless standard may be used. The speaker system 10 controls may be represented as an on-screen display sound parameter scales. The user accesses the scales using a remote controller and the flat panel's on-screen display. The scales are presented to the user via the on-screen display when the user enters the configuration mode. The user adjusts the configurations of the various sub parameters using a single scale that runs from ‘−10’ to ‘+10’. The scale settings are set by the listener and adjusted for listener taste and the listening environment. The amount of processing required to achieve the desired audio effect varies greatly depending on room acoustics, audio media (music, gaming, movies), and listener preferences.

In an alternative embodiment, the scale controls are embodied in a smart phone application. Current smart phones incorporate a Bluetooth® wireless function that allows for short range pairing and radio frequency communications of electronic devices. In the smart phone embodiment of the current invention, an application is downloaded to the phone. The application essentially allows the user to replace the flat panel's remote control with the smart phone to control the functionality of the speaker system. The speaker includes a Bluetooth® or other short range radio frequency capability and is paired to the Smartphone.

FIG. 2 show the outer portion 44 of the enclosure 16. The outer portion 44 may be secured to the inner mounting portion 12 using bolts, clips, or other know means. The outer portion 44 include a number of acoustic transducers and is configured to provide acoustic output that enhance acoustic sound stage imaging and the surround sound experience.

The outer portion 44 of the enclosure 16 comprises a woofer enclosure 46 that allows for internal mounting of a low frequency woofer speaker 50. The woofer 50 is generally configured within the enclosure 16 to face outward in a position normal to the longest edge of the plane of the mounted flat panel and is covered by a grate of strong mesh 48 to protect the woofer 50. Directionality of the woofer 50 output is not of primary concern because the human ear is less discerning of the origin location of low frequency sounds. There are a number of flat low frequency speaker configurations which are known in the art that may be utilized to keep the profile of the speaker system 10 thin.

The enclosure 16 may also include one or more ported chambers 54 where low frequency sounds resonate and are reverberated to escape through the port 54 at the exterior portion of the enclosure 16, providing a deeper richer low frequency timbre without the need for an external subwoofer. The amplifier 14 may be associated with the woofer 50 to provide additional power to the woofer 50.

The enclosure 16 may further be divided into sub-enclosures 52 (in accordance with a number of main and surround channels) that act as acoustic volumes of space 56 for midrange transducers which are placed to allow their output to reach the listeners by first reflecting off of rear, side or ceiling surfaces of the listening room. In this manner, the digital signal processing methods discussed above are used to create a realistic surround sound experience.

The transducers 42 are mounted in the enclosure 16 such that direction of audio transmission from the transducer is generally normal to the surface of the display Multiple transducers 42 might be used in an array to form a more wider sound field. transducers 42 may also be tilted to allowing for high frequency audio signals to be directed or reflected towards the listeners when viewing the display. Phase and amplitude management among the array elements may be used to create a more even or directed sound field. In some embodiments, speaker drivers 42 may be advantageous placed at the outer perimeter edge of the enclosure 16, which may be beveled and may allow speaker mounting at various angles. The slope of the angles might vary to allow sound waves to be directed or to reflect off of the rear walls behind or the ceiling above the flat panel and otherwise direct the acoustic waveform to provide the listener with a more convincing and immersive sound image corresponding to a video image when viewing the flat panel display. Additional speaker placement design techniques may be use to enhance the directionality of specific speaker 42 frequencies. The enclosure 16, sub-enclosures 52 and ports 54 may be vented along the beveled edge of the enclosure 16 or the rear panel to provide sound transmission to the exterior environment.

The system 10 may also further comprise indicators such as LED lights of different colors, each color representing a different use state such as on, off, or configuration mode or wireless pairing modes. The system 10 may include a wireless communications means such as an infrared sensor for communication with a handheld remote control. It is contemplated that the forward facing high frequency transducers 26, the LED indicators and infrared sensor might alternatively be placed in a small module outside the slide-able structure or may be separately configured to mount in any convenient manner.

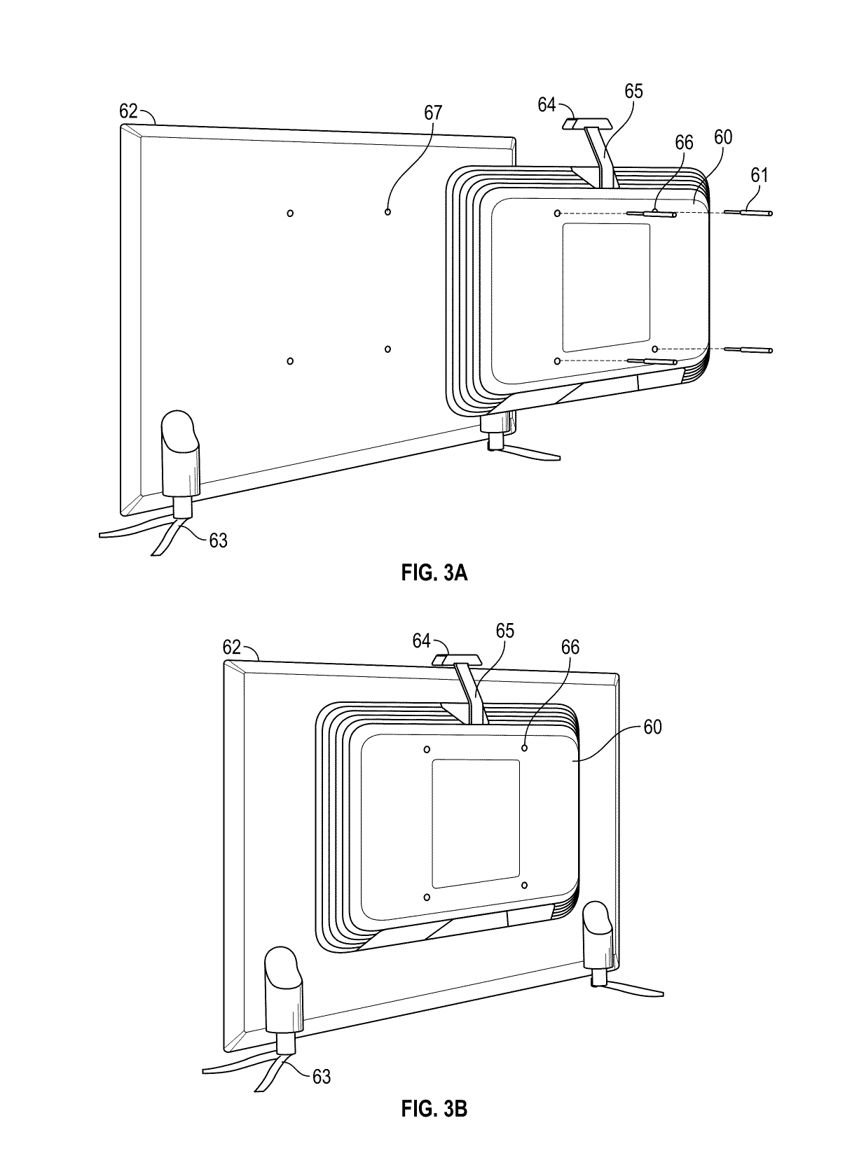

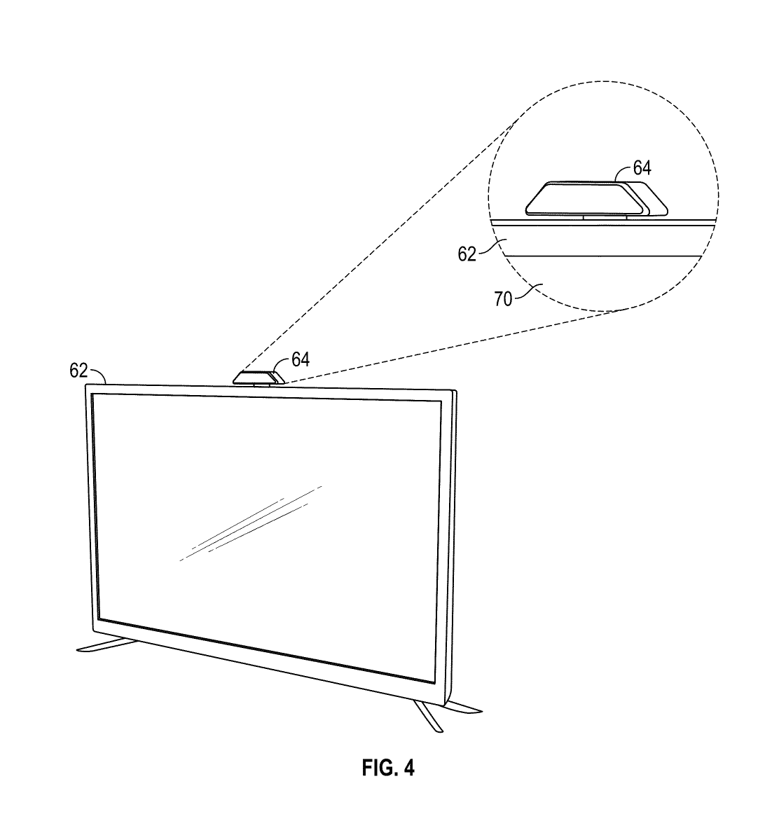

FIGS. 3A and 3B demonstrate the attachment of the speaker system 60 to the flat panel display 62. In the embodiment shown, the flat panel 62 and speaker system 60 are supported by the stand 63 provided with the flat panel 62. The flat panel 62 also incorporates bolt holes 67 intended to support wall mounting of the flat panel 62. The speaker system 60 is mounted to the back side of the flat panel 62 by securing bolts 61 through the mounting holes 66 through the speaker system 60 and threaded into the flat panel bolt holes 67. When mounted the forward facing speaker 64 is raised by means of the adjustable sliding arm 65 to fit over the edge of the flat panel 62. FIG. 4 shows the front side of the flat panel display 62 with an expanded view 70 of the forward facing speaker 64.

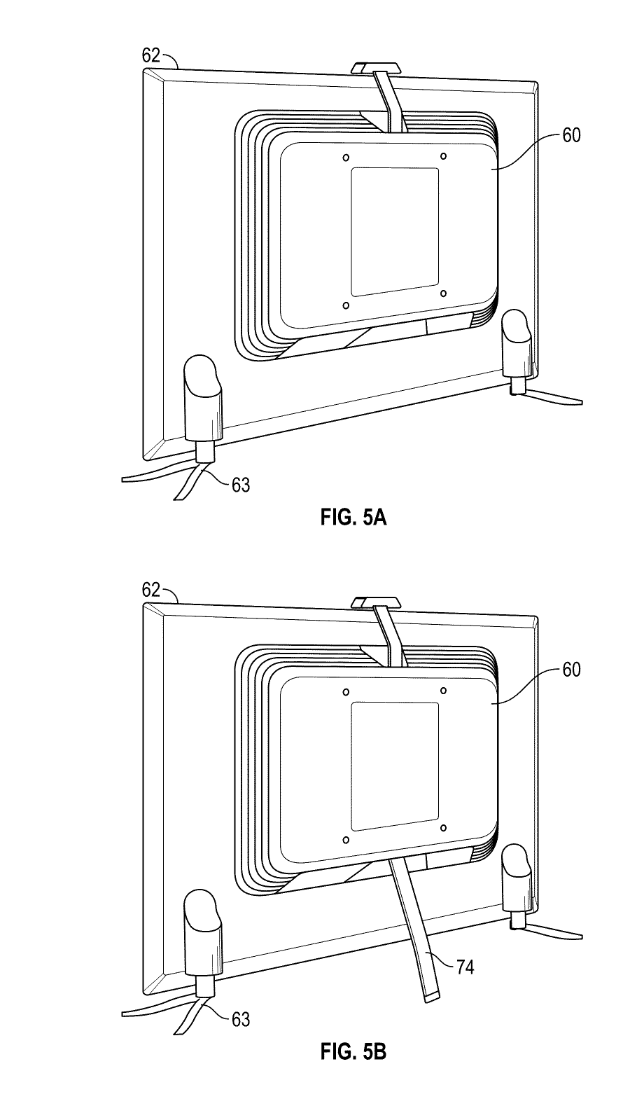

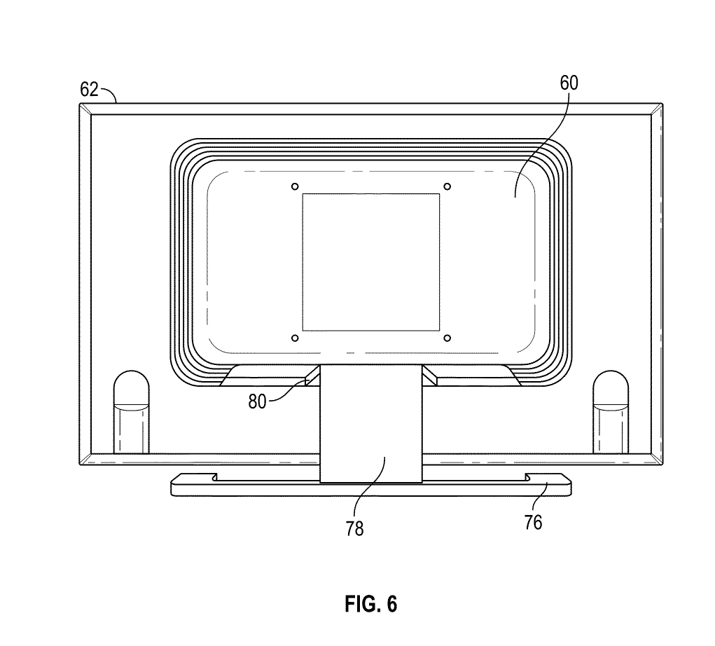

Now with reference to FIGS. 5A, 5B and 6, shown are various embodiments of the support system configurations of the flat panel. FIGS. 5A and 5B shows the speaker system 60 mounted to the flat panel display 62. The conjoined system is supported using the factory flat panel supports 63. FIG. 5B shows addition support provided by a retractable support member 74 that can be retracted from the speaker system 60 and lock at a preferred length by locking mechanism (not shown). FIG. 6 shows yet a third embodiment for supporting the conjoined flat panel 62 speaker system 60. The speaker system 60 includes a slot (not visible) whereby a base 76 is inserted to provide support. The base support 76 includes a base upright 78 that extends through the core of the speaker system 60. The upright 78 is supported within the speaker system 60 by reinforced frame structure (not shown). It is contemplated that the reinforced frame support may be a slot where the base upright 78 may be inserted into speaker system 60 within a slot and groove configuration. The length of the upright 78 may be adjusted by any well know locking mechanism 80.

While the foregoing written description of the invention enables one of ordinary skill to make and use the invention, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The present invention thus can be embodied in other specific forms without departing from its spirit or essential characteristics. The described embodiment is to be considered in all respects only as illustrative and not restrictive. The scope of the invention is, therefore, indicated by the appended claims rather than by the foregoing description.

1. A flat panel speaker system comprising:
an enclosure comprising a front panel and a rear panel, an interior cavity formed between the front panel a rear panel, the enclosure having a means for coupling directly to a flat panel display and configured with vented areas to provide for transmissions of sound to the exterior environment and further configured to house:
a plurality of acoustic transducers for generating said sound;
a power supply for providing electrical power to the speaker system components;
at least one audio signal connector for receiving audio signals from an audio signal source;
an amplifier electrically coupled to the signal processor and the plurality of acoustic transducers and whereby the audio signal is amplified and communicated to said plurality of transducers for generation of sound.

2. The speaker system of claim 1, wherein the plurality of acoustic transducers for generating said sound comprise:
at least one low frequency speaker,
at least one mid range speaker, and
at least one high frequency speaker.

3. The speaker system of claim 2, wherein the at least one low frequency speaker, the at least one mid range speaker and the at least one high frequency speaker are configured to provide a multi-dimensional sound stage.

4. The speaker system of claim 1, wherein the generated sound corresponds to the video image displayed on the flat panel display.

5. The speaker system of claim 3, wherein the generated sound corresponds to the video image displayed on the flat panel display.

6. The speaker system of claim 1 wherein the interior cavity is configured to provide a speaker mounting chamber for directionally mounting of the plurality of acoustic transducers for generating said sound to enhance the directing the generated sound to a location in front of the flat panel display.

7. The speaker system of claim 1, wherein the enclosure is not wider than 2.5 inches

8. The speaker system of claim 1, wherein the enclosure is further comprised of a frame structure for securing a speaker support member wherein the support member supports the at least one high frequency speaker in a direction whereby sound projects forward of the flat panel display

9. The speaker system of claim 8 wherein the support member is in a retracted when the speaker system is stowed and the support member is in a deployed position when the speaker system is coupled to the flat panel display.

10. The speaker system of claim 1 wherein the enclosure is further comprised of a stand support structure for securing a stand for supporting the speaker system and flat panel display in an upright position.

11. The speaker system of claim 8 wherein the stand for supporting the speaker system and flat panel display in an upright position is removably inserted into the stand support structure.

12. The speaker system of claim 2 further comprised of a digital signal processor for processing audio signals received from the at least one audio source.
